(19) United States
(12) Patent Application Publication
(10) Pub. No.: US 2023/0154151 A1
(43) Pub. Date: May 18, 2023

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: Yukiko Uno, Kanagawa (JP)

(21) Appl. No.: 17/979,256

(22) Filed: Nov. 2, 2022

(30) Foreign Application Priority Data
Nov. 16, 2021 (JP) 2021-186521

(51) Int. Cl. G06V 10/764; G06V 10/776; G06V 10/70

(52) U.S. Cl. CPC G06V 10/764; G06V 10/776; G06V 10/87

(57) ABSTRACT

An image processing apparatus comprises a training unit configured to train a learning model using first training data including a first region, which has been given a first classification label, in an input image; an estimation unit configured to perform estimation using the trained learning model and verification data; a generation unit configured to, in a case where an accuracy of a result of the estimation by the estimation unit is less than or equal to a first threshold, give the first region one of second classification labels, into which the first classification label has been subdivided, and generate second training data including the first region, which has been given the second classification label; and a control unit configured to cause the training unit to perform retraining using the second training data.

### BACKGROUND OF THE INVENTION

### Field of the Invention

The present invention relates to an image processing apparatus for detecting a specific object from an image.

### Description of the Related Art

Recently, many techniques for detecting specific objects from images by machine learning have been proposed. To create a trained model, it is necessary to create training data in which position and label information of an object to be detected has been given to an image for training and teach parameters with a program for training. When detecting objects using this trained model, an erroneous label may be outputted for a certain object. Especially, if features of objects which have been given the same labels vary greatly in an image for training, parameters may not successfully be taught, and thereby an estimation accuracy may decrease.

For example, when it is desired to create a trained model for detecting a plurality of types of lesions from an image at a medical site, if training data is created using the name of a lesion as a label, the same label will be given to lesions whose appearances greatly differ depending on the state of progression of the lesion, the part on which the lesion has appeared, and the like. Therefore, a detection accuracy may decrease.

Japanese Patent Laid-Open No. 2021-51589 proposes a technique for improving a detection accuracy in a hierarchical neural network. The overall accuracy is improved by extracting erroneously classified data for a trained model that has once been generated, adding layers for determining and classifying data that tends to be erroneously classified, and then performing retraining.

With the method disclosed in Japanese Patent Laid-Open No. 2021-51589, since the structure of a trained model is changed, there are problems, such as that the data size of a model and the computational complexity of estimation may increase.

In addition, when creating training data, attempts have been made to improve accuracy by giving different labels to data having different features in appearance, but it requires an operator to visually inspect an image for training, classify it by the features of its appearance, and redo the labeling, thereby taking a lot of man-hours.

### SUMMARY OF THE INVENTION

The present invention has been made in view of the above problems and provides an image processing apparatus capable of improving an accuracy of object detection while using a learning model of the same structure.

According to a first aspect of the present invention, there is provided an image processing apparatus comprising: at least one processor or circuit configured to function as: a training unit configured to train a learning model using first training data including a first region, which has been given a first classification label, in an input image; an estimation unit configured to perform estimation using the trained learning model and verification data; a generation unit configured to, in a case where an accuracy of a result of the estimation by the estimation unit is less than or equal to a first threshold, give the first region one of second classification labels, into which the first classification label has been subdivided, and generate second training data including the first region, which has been given the second classification label, and a control unit configured to cause the training unit to perform retraining using the second training data.

According to a second aspect of the present invention, there is provided an image processing method comprising: training a learning model using first training data including a first region, which has been given a first classification label, in an input image; performing estimation using the trained learning model and verification data; in a case where an accuracy of a result of the estimation by the estimation unit is less than or equal to a first threshold, giving the first region one of second classification labels, into which the first classification label has been subdivided, and generating second training data including the first region, which has been given the second classification label; and in the training, performing retraining using the second training data.

According to a third aspect of the present invention, there is provided a non-transitory computer-readable storage medium storing a program causing a computer to function as respective units of an image processing apparatus, the image processing apparatus comprising: a training unit configured to train a learning model using first training data including a first region, which has been given a first classification label, in an input image; an estimation unit configured to perform estimation using the trained learning model and verification data; a generation unit configured to, in a case where an accuracy of a result of the estimation by the estimation unit is less than or equal to a first threshold, give the first region one of second classification labels, into which the first classification label has been subdivided, and generate second training data including the first region, which has been given the second classification label; a control unit configured to cause the training unit to perform retraining using the second training data.

Further features of the present invention will become apparent from the following description of exemplary embodiments with reference to the attached drawings.

### BRIEF DESCRIPTION OF THE DRAWINGS

FIG. 1 is a system configuration diagram of an image processing apparatus according to a first embodiment.

FIGS. 2A and 2B are diagrams for explaining labels of objects to be detected in the first embodiment.

FIGS. 3A and 3B are diagrams illustrating structures of training data and verification data in the first embodiment.

FIG. 4 is a flowchart for explaining a process of generating a trained model in the first embodiment.

FIG. 5 is a diagram illustrating an example of a screen configuration of a user interface according to a second embodiment.

FIG. 6 is a flowchart for explaining a process of generating a trained model in the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, a description will be given for an image processing apparatus for generating a trained model for detecting from an image a position and a type for a plurality of lesions, which have been set in advance as detection targets. In the present embodiment, it is assumed that a machine learning algorithm according to deep learning or the like is used as a method for estimation. Although a detection target is a lesion in the present embodiment, an object to be detected by the present invention is not limited to this.

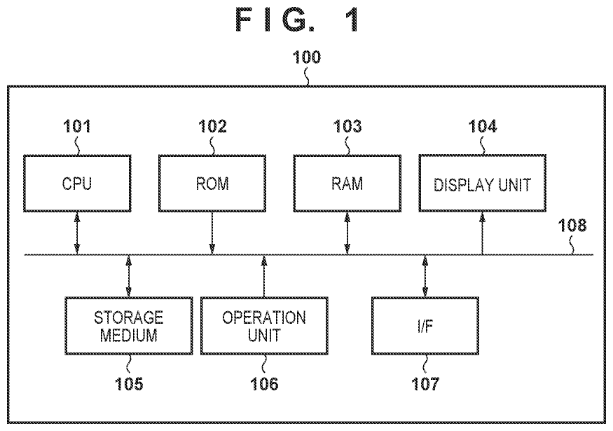

FIG. 1 is a system configuration diagram of an image processing apparatus 100 according to a first embodiment of the present invention.

In FIG. 1, a central processing unit (hereinafter, CPU) 101 controls the entire image processing apparatus 100 by executing a program. A read only memory (hereinafter, ROM) 102 stores programs and parameters. In the present embodiment, the ROM 102 stores program codes of software to be executed by the CPU 101, necessary parameters, and the like. These program codes are executed by the CPU 101. The ROM 102 of the present embodiment is a flash ROM, and it is possible to rewrite control programs therein.

A random access memory (hereinafter, RAM) 103 temporarily stores programs and data supplied from an external unit. The RAM 103 is also used as a temporary storage area for data outputted with execution of programs. A display unit 104 is a display unit, such as a liquid crystal display, and displays a graphical user interface (GUI) screen of software, a result of processing, and the like.

A storage medium 105 is a storage medium from which/to which the image processing apparatus 100 can read/write data. The storage medium 105 is a medium capable of storing electronic data, such as an internal memory provided in a computer, a memory card removably connected to a computer, a hard disk drive (HDD), a CD-ROM, an MO disk, an optical disk, a magneto-optical disk, and the like. The storage medium 105 stores data for estimation; estimation results; data for generating estimation data, such as training data; and the like.

An operation unit 106 is configured to include a keyboard, a mouse, and the like, and it is possible to specify input/output data, change a program, execute or abort image processing, and the like by an instruction inputted via the operation unit 106. An interface (I/F) 107 is an interface for communicating with an external system. An internal bus 108 is a transmission path for control signals and data signals between the respective components.

The respective functions of the image processing apparatus 100 are realized by predetermined programs on hardware, such as the CPU 101 and the ROM 102 being read and the CPU 101 performing computation. Further, the respective functions are realized by communication that is performed by the I/F 107 and control for reading and writing of data in the RAM 103 and the storage medium 105.

In the present embodiment, a description will be given using an example in which the CPU is mounted as the main control unit of the image processing apparatus in order to facilitate understanding of the description; however, the present invention is not limited to this. For example, a graphics processing unit (GPU) may be mounted in addition to the CPU, and the CPU and the GPU may execute processing in coordination. Since the GPU can efficiently perform computation by processing more data in parallel, when performing training over a plurality of times using a learning model, such as in deep learning, it is effective to perform processing with the GPU. Specifically, when executing a training program including a learning model, training is performed by the CPU and the GPU performing computation in coordination. Configuration may be such that computational processing of a training unit is performed only by the CPU or by the GPU. In addition, the processing of an estimation unit may be executed using the GPU in the same manner as the processing of the training unit.

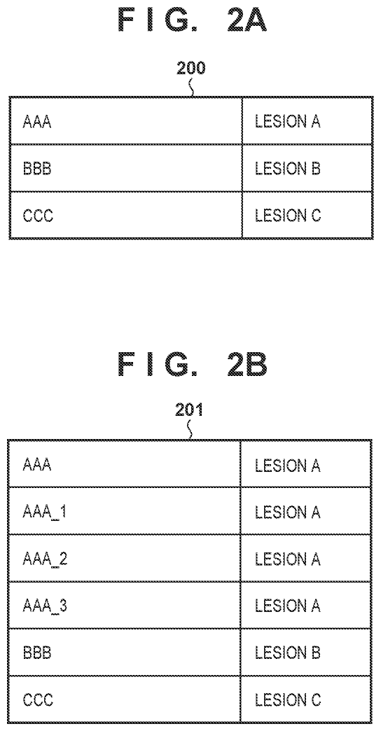

FIGS. 2A and 2B are diagrams for explaining labels for objects to be detected in an input image. FIG. 2A illustrates a label list 200. The label list 200 is configured by a combination of a label and the name of a lesion and indicates that a label “AAA” is a label representing a lesion A. FIG. 2B illustrates a label list 201 that has been updated by trained model generation processing, which will be described later. Details will be described later.

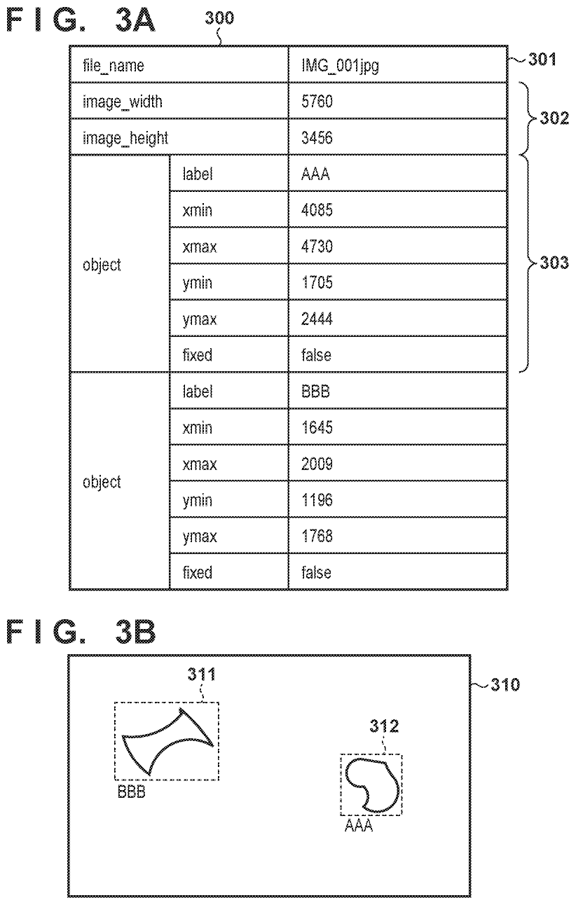

FIGS. 3A and 3B are diagrams illustrating structures of training data and verification data. FIG. 3A illustrates an annotation information list 300 given to one image file. In the present embodiment, it is assumed that the annotation information list 300 is stored in an XML format. Image identification information 301 is information for identifying a corresponding image file and, in the present embodiment, stores an image file name. Image size information 302 is information related to the resolution of the entire image and, in the present embodiment, stores the numbers of vertical and horizontal pixels of the entire image.

Annotation information 303 is annotation information of an object to be detected and is configured by intra-image position information and a label. In the present embodiment, a left-edge coordinate xmin, a right-edge coordinate xmax, an upper-edge coordinate ymin, and a lower-edge coordinate ymax of a rectangle surrounding an object to be detected in the image are stored as the position information. The position information may be of a shape other than a rectangle, and it may be, for example, of a circle or another arbitrary shape so long as it coincides with or can be converted to input of the training program and output of an estimation program. One of the labels listed in the label list 200 is stored as a label. The annotation information 303 is stored as many as the number of objects to be detected included in the image.

FIG. 3B illustrates an image file 310. Rectangles 311 and 312 are visualizations of annotation information that has been given to the lesion A and a lesion B included in the image file 310, respectively. The actual image file 310 does not include shapes, such as rectangles 311 and 312, and the annotation information is stored in a separate file as illustrated in FIG. 3A. The training data and verification data are configured by a plurality of combinations of the annotation information list 300 and the image file 310.

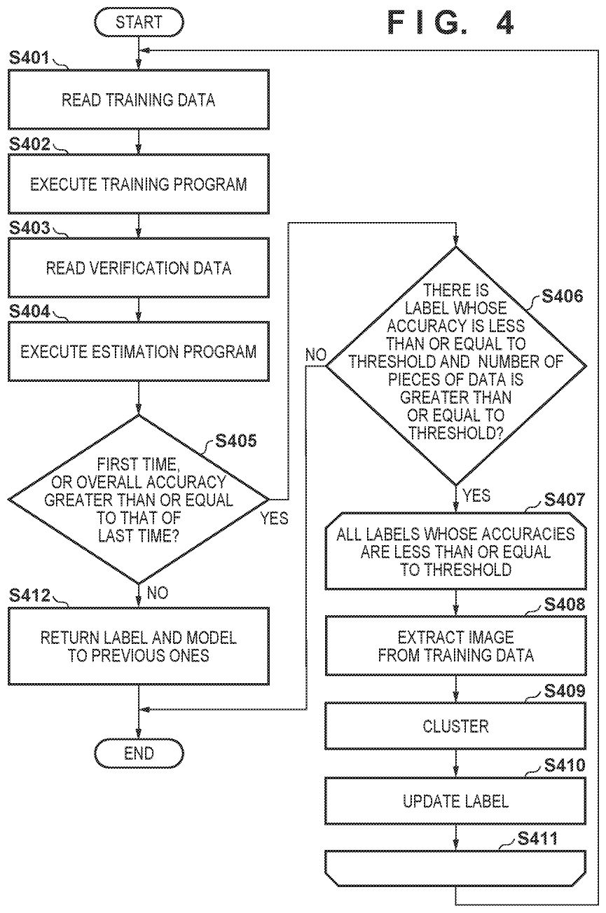

FIG. 4 is a flowchart for explaining processing in which the image processing apparatus 100 generates a trained model. The processing indicated in this flowchart is realized by the CPU 101 of the image processing apparatus 100 controlling the respective units of the image processing apparatus 100 in accordance with an input signal or the programs stored in the ROM 102. Unless otherwise specified, the same applies to other flowcharts for explaining processing of the image processing apparatus 100.

In step S401, the CPU 101 reads training data of a structure described with reference to FIGS. 3A and 3B.

In step S402, the CPU 101 executes the training program using the training data read in step S401 to generate a trained model for object detection.

In step S403, the CPU 101 reads verification data of a structure described with reference to FIGS. 3A and 3B.

In step S404, the CPU 101 performs object detection by executing the estimation program using the trained model generated in step S402 with an image file of the verification data read in step S403 as input, and obtains an estimation result. The estimation result is configured in the same manner as the annotation information list 300 in FIG. 3A.

In step S405, the CPU 101 compares the estimation result obtained in step S404 with the annotation information of the verification data read in step S403 to calculate the overall accuracy. A method for calculating an accuracy will be described later. If it is the first time executing step S405, or if the overall accuracy is greater than or equal to a value when step S405 was last executed (if an accuracy has improved), the CPU 101 advances the processing to step S406, and otherwise, the CPU 101 advances the processing to step S412.

In step S406, the CPU 101 calculates for each label listed in the label list 200 an accuracy and the number of pieces of data included in the training data. Then, the CPU 101 determines whether or not an accuracy is less than or equal to a predetermined threshold set for accuracy and the number of pieces of data is greater than or equal to a predetermined threshold set for the number of pieces of data in any of the labels. If the accuracy is less than or equal to the predetermined threshold set for accuracy and the number of pieces of data is greater than or equal to the predetermined threshold set for the number of pieces of data in any of the labels, the CPU 101 advances the processing to step S407, and otherwise, the CPU 101 ends the processing. Each threshold may be a value predetermined by the program or a value specified by the user.

Step S407 to step S411 is a loop in which the CPU 101 sequentially processes respective labels whose accuracy has been determined in step S406 to be less than or equal to the predetermined threshold set for accuracy. The following processing is performed for each label. In the following description, “AAA” is set as a label to be processed.

In step S408, the CPU 101 extracts from all annotation information lists of the training data read in step S401 annotation information in which a label of “AAA” is held and cuts out from the image file a partial image indicated by the position information.

In step S409, the CPU 101 performs clustering (subdivision) by unsupervised learning with all the partial images that have been cut out in step S408 as input. An algorithm for unsupervised learning is not specifically limited. The number of clusters may be a value predetermined by the program or a value specified by the user. Alternatively, the number of clusters may be automatically determined by the algorithm for unsupervised learning. In the present embodiment, the number of clusters is set to 3. As a result of this processing, all partial images are classified into three.

In step S410, the CPU 101 updates the labels based on a result the clustering of step S409. Specifically, the label names of respective clusters are set to “AAA_1”, “AAA_2”, and “AAA_3”, and the label of the annotation information of the training data that is a source from which the partial images classified into the cluster of “AAA_1” have been cut out is changed to “AAA 1”. In addition, the label list is updated as illustrated in the label list 201 of FIG. 2B. That is, the label list 201 in which information, which indicates that newly created “AAA_1,” “AAA_2,” and “AAA_3” are all labels indicating the lesion A, has been added is created. In addition, the estimation program to be executed in step S404 is changed so that if the estimation result is one of “AAA_1”, “AAA_2”, and “AAA_3”, the label “AAA” is outputted.

In step S411, the CPU 101 performs the next loop. When all the labels have been processed, the CPU 101 returns the processing to step S401.

In step S412, the CPU 101 returns the label that was updated when step S410 was last executed and the trained model that was generated when step S402 was executed to a previous state and terminates the processing.

Here, a description will be given on a method for calculating the accuracy in steps S405 and S406 of FIG. 4. Generally there are a plurality of metrics for an accuracy in object detection, but in the present embodiment an average precision is assumed. Regarding the correctness of the estimation result, a comparison is performed against the coordinates of a rectangle included in the annotation information of the verification data, and if Intersection over Union (IoU) is 0.5 or more and the result holds the same label, the result is deemed correct, and otherwise, the result is deemed erroneous.

In step S405 of FIG. 4, the CPU 101 adopts as the overall accuracy an average of average precisions of the respective label, that is, a value obtained by dividing a sum of average precisions by the number of lesions. In step S406 of FIG. 4, the CPU 101 calculates an average precision for each lesion. If there are variations in the number of pieces of data included in the verification data among the lesions, the calculation may be performed by weighting with the number of pieces of data.

As described above, according to the image processing apparatus of the present embodiment, in the processing for generating a trained model for object detection, training data of a label whose detection accuracy is low is subdivided by unsupervised learning, the subdivisions are given separate labels, and then retraining is performed. Thus, it is possible to attempt to suppress a decrease in accuracy caused by variations in features within the same label, thereby improving the overall accuracy. Also, by performing these processes automatically, it is possible to improve the accuracy without manually updating the annotation information.

### Second Embodiment

In the first embodiment, a description has been given for an example in which it is automatically determined whether or not to continue updating a label and performing retraining. In the present embodiment, a description will be given for an example in which the user can confirm an update state of a label and retraining can be instructed in accordance with the user's operation.

In the present embodiment, descriptions will be omitted for portions that are the same as in the first embodiment, and a description will be given mainly for configurations that are unique to the present embodiment.

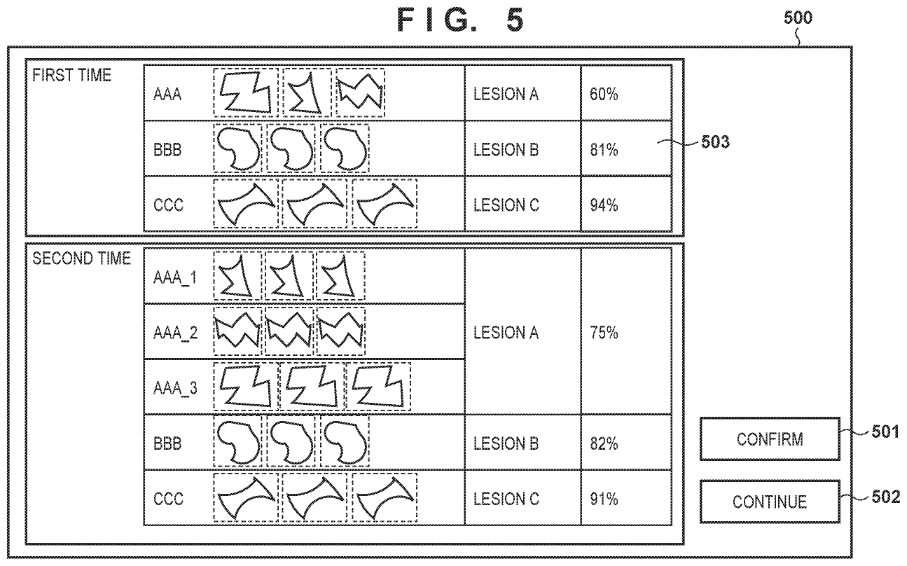

FIG. 5 is a diagram illustrating a configuration example of a user interface (UI) 500 displayed on the display unit 104 by the image processing apparatus 100. A confirmation button 501 is used for determining labels and the trained model based on a history of retraining and can perform an instruction for terminating training. A continuation button 502 is used for the user to instruct to continue training. In a history list 503 is displayed the label list 201 for each time training has been performed, an accuracy of each lesion based on an estimation result of the verification data, and some of the images of training data to which each label has been given. It is assumed that the training data to be displayed is selected at random. The user can set (select) a history to be in a selected state by clicking on any history in the history list 503.

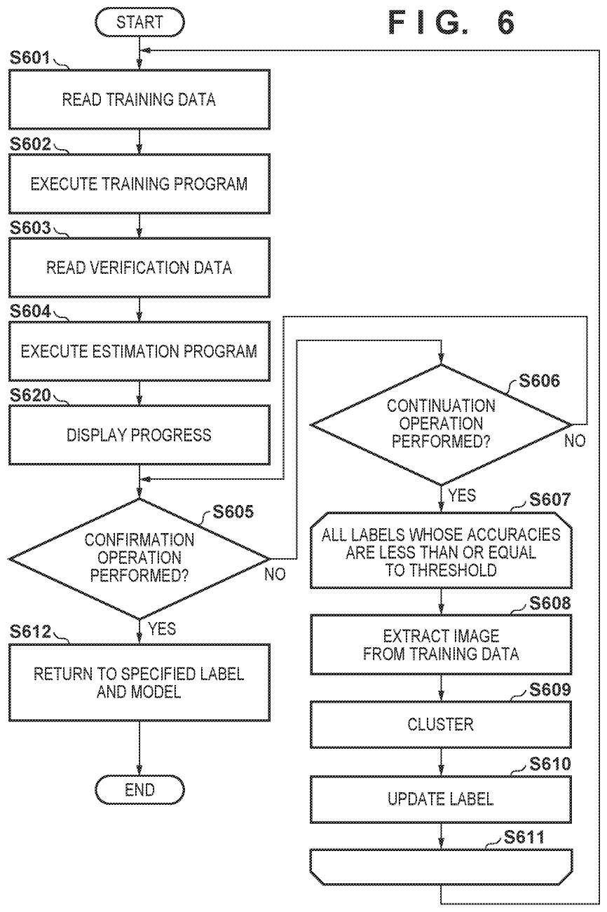

FIG. 6 is a flowchart for explaining processing for generating a trained model by the image processing apparatus 100.

In step S601 to step S604, the same processing as in step S401 to step S404 in FIG. 4 is performed, respectively.

In step S620, the CPU 101 displays the UI 500 on the display unit 104. Then, the CPU 101 displays in the history list 503 the label list 201 updated when step S610 was last performed, a portion of the training data read in step S601, and an accuracy of each lesion in a result of the estimation of step S604.

In step S605, the CPU 101 receives the user's operation, and if the user has pressed the confirmation button, the CPU 101 advances the processing to step S612, and otherwise, the CPU 101 advances the processing to step S606.

In step S606, the CPU 101 receives the user's operation, and if the user has pressed the continuation button, the CPU 101 advances the processing to step S607, and otherwise, the CPU 101 returns the processing to step S605.

In step S607 to step S611, the same processing as in step S407 to step S411 in FIG. 4 is performed, respectively.

In step S612, the CPU 101 returns, based on a history in a selected state among those in the history list 503 on the UI 500, the label updated in step S610 and the trained model generated in step S602 to a state of a round of the selected history and terminates the processing.

As described above, according to the image processing apparatus of the present embodiment, it is possible to end the processing at a timing desired by the user by selecting whether to continue retraining or return to a specified state in accordance with the user's instruction.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-186521, filed Nov. 16, 2021, which is hereby incorporated by reference herein in its entirety.

What is claimed is:

1. An image processing apparatus comprising:
at least one processor or circuit configured to function as:
a training unit configured to train a learning model using first training data including a first region, which has been given a first classification label, in an input image;
an estimation unit configured to perform estimation using the trained learning model and verification data;
a generation unit configured to, in a case where an accuracy of a result of the estimation by the estimation unit is less than or equal to a first threshold, give the first region one of second classification labels, into which the first classification label has been subdivided, and generate second training data including the first region, which has been given the second classification label; and
a control unit configured to cause the training unit to perform retraining using the second training data.

2. The image processing apparatus according to claim 1, wherein the generation unit subdivides the first classification label into the second classification labels by unsupervised learning.

3. The image processing apparatus according to claim 1, wherein the control unit repeats retraining until the accuracy of the result of the estimation stops improving.

4. The image processing apparatus according to claim 1, wherein the generation unit adopts an average of average precisions of respective labels as the accuracy of the result of the estimation.

5. The image processing apparatus according to claim 1, wherein the generation unit sets the number of subdivisions to a predetermined number.

6. The image processing apparatus according to claim 1, wherein the generation unit sets the number of subdivisions in accordance with a user's specification.

7. The image processing apparatus according to claim 1, wherein in a case where the number of pieces of data included in the first training data is greater than or equal to a second threshold, the generation unit performs the subdivision.

8. The image processing apparatus according to claim 1, wherein the at least one processor or circuit is configured to further function as:
a display unit configured to display a state of training every time training of the learning model is performed; and a selection unit configured to enable a user to select whether or not to execute retraining.

9. The image processing apparatus according to claim 8, wherein the selection unit enables the user to select one state from among respective states of training of the learning model displayed on the display unit.

10. An image processing method comprising:
training a learning model using first training data including a first region, which has been given a first classification label, in an input image;
performing estimation using the trained learning model and verification data;
in a case where an accuracy of a result of the estimation by the estimation unit is less than or equal to a first threshold, giving the first region one of second classification labels, into which the first classification label has been subdivided, and generating second training data including the first region, which has been given the second classification label, and
in the training, performing retraining using the second training data.

11. A non-transitory computer-readable storage medium storing a program causing a computer to function as respective units of an image processing apparatus, the image processing apparatus comprising:
a training unit configured to train a learning model using first training data including a first region, which has been given a first classification label, in an input image;
an estimation unit configured to perform estimation using the trained learning model and verification data;
a generation unit configured to, in a case where an accuracy of a result of the estimation by the estimation unit is less than or equal to a first threshold, give the first region one of second classification labels, into which the first classification label has been subdivided, and generate second training data including the first region, which has been given the second classification label;
a control unit configured to cause the training unit to perform retraining using the second training data.
